(19) United States
(12) Patent Application Publication
(10) Pub. No.: US 2024/0418929 A1
(43) Pub. Date: Dec. 19, 2024

(54) MULTICORE TRANSMISSION APPARATUS, COMPLEX JOINT BOX, AND MULTICORE FIBER ACCOMMODATION METHOD

(71) Applicant: NEC Corporation, Minato-ku, Tokyo (JP)

(72) Inventor: Koji INADA, Tokyo (JP)

(73) Assignee: NEC Corporation, Minato-ku, Tokyo (JP)

(21) Appl. No.: 18/704,528

(22) PCT Filed: Nov. 10, 2021
(86) PCT No.: PCT/JP2021/041330

§ 371 Date: Apr. 25, 2024

(51) Int. Cl. G02B 6/02; G02B 6/38; G02B 6/44

(52) U.S. Cl. CPC G02B 6/02042; G02B 6/3885; G02B 6/44715

(57) ABSTRACT

A multicore transmission apparatus includes: first to fourth multicore fibers each having a plurality of cores; a first multicore device for outputting a plurality of light beams, which have been inputted from the respective cores of the first multicore fiber and which have been individually processed, to mutually different cores of the second multicore fiber; a second multicore device for outputting a plurality of light beams, which have been inputted from the respective cores of the third multicore fiber and which have been individually processed, to mutually different cores of the fourth multicore fiber; a first joint box for accommodating the first multicore fiber, the first multicore device, the second multicore fiber, and the fourth multicore fiber; and a second joint box for accommodating the second multicore fiber, the third multicore fiber, the second multicore device, and the fourth multicore fiber.

### TECHNICAL FIELD

The present invention relates to a multicore transmission apparatus, a complex joint box, and a multicore fiber accommodation method, and more particularly, to a multicore transmission apparatus, a complex joint box, and a multicore fiber accommodation method that accommodate a multicore fiber by using a joint box.

### BACKGROUND ART

In terrestrial and submarine optical transmission systems using optical fibers, bands (wavelength bands) of an original-band (O-band), an extended-band (E-band), a short-band (S-band), a conventional-band (C-band), and a long-band (L-band) are mainly used. The O-band indicates a wavelength band of 1260 to 1360 nm, the E-band indicates a wavelength band of 1360 to 1460 nm, the S-band indicates a wavelength band of 1460 to 1530 nm, the C-band indicates a wavelength band of 1530 to 1565 nm, and the L-band indicates a wavelength band of 1565 to 1625 nm. When only one wavelength band of the O-band, the E-band, the S-band, the C-band, and the L-band is referred to, the wavelength band may be referred to as a “single band”.

In conventional optical transmission systems, a single-core fiber accommodated in an optical cable is used, whereby a wavelength division multiplexing (WDM) signal is transmitted. Therefore, in order to increase a communication capacity of the system, it is necessary to increase the number of fibers. However, in particular, in an optical transmission system using a submarine cable (hereinafter referred to as a “submarine transmission system”), since it is necessary to pull up the submarine cable in order to increase the number of cores of the optical fiber to be accommodated in the submarine cable, a large cost is required for adding the optical fiber. For this reason, in recent years, it has been studied to mount a multicore fiber having a plurality of cores in one optical fiber on an optical cable in advance. By using an optical cable on which a multicore fiber is mounted (hereinafter, referred to as a “multicore cable”), since the number of cores per optical cable increases, even when an amount of transmission data in the submarine transmission system increases, it is possible to secure a transmission capability by using an unused core, without adding an optical fiber. Such an optical transmission system is also called an optical space multiplexing optical transmission system. Hereinafter, an optical transmission system using a multicore fiber is described as a multicore transmission system.

In connection with the present invention, PTL 1 describes a multiband signal processing system in which an optical signal acquired by wavelength-multiplexing optical signals of a first band and a second band is received and equalization processing is performed for each band by using an equalizer device. PTL 2 describes a technique related to transmission of a wavelength-multiplexed optical signal using a multicore fiber.

In a transmission apparatus to be used in a submarine cable system, an equalizer device is accommodated in a joint box (JB) such as a factory joint (FBJ) or a universal joint (UJ). A general joint box can accommodate up to 16 equalizer devices.

FIG. 9 is a diagram illustrating a configuration of a general multiband signal processing system 900, which is described in PTL 1. The multiband signal processing system 900 includes joint boxes (JBs) 901 and 902. A wavelength-multiplexed optical signal being input from a signal cable 910 to a multiband signal device 920 is separated into a C-band optical signal and an L-band optical signal in a coupler 921. The separated optical signals are equalized (equalizing) in each of the bands by EQL devices 922 and 923 provided for each band. The equalized C-band optical signal and L-band optical signal are multiplexed by a coupler 924. An optical signal acquired by multiplexing the C-band optical signal and the L-band optical signal is transmitted to a signal cable 930. The coupler 921 is an optical demultiplexer, and separates the wavelength-multiplexed optical signal into a C-band and an L-band. The coupler 924 is an optical multiplexer, and multiplexes an input C-band optical signal and an input L-band optical signal. The multiband signal processing system 900 includes signal cables 960 and 980 and a multiband signal device 970 that perform similar processing on reverse optical signals.

### CITATION LIST

### Patent Literature

PTL 1: International Patent Publication No. WO2017/145973
PTL 2: Japanese Unexamined Patent Application Publication No. 2012-222613

### SUMMARY OF INVENTION

### Technical Problem

In a joint box to which a submarine cable including a multicore fiber is connected, it is necessary to perform processing such as equalizing for each light beam propagating through each core. Namely, the joint box is required to be able to accommodate a device such as an equalizer device connected to each core of the multicore fiber at high density.

The multiband signal processing system 900 in FIG. 9 separates the wavelength-multiplexed optical signal including the C-band optical signal and the L-band optical signal, which is input from the signal cable 910, into the C-band and the L-band, and equalizes the wavelength-multiplexed optical signal for each band by using the EQL devices 922 and 923. Namely, the multiband signal processing system 900 describes a configuration for separating an optical signal propagated through a single-core fiber for each band and equalizing the resultants for each separated optical signal. However, the multiband signal processing system 900 does not disclose a configuration for densely accommodating a device for processing optical signals for each core in a joint box to which a multicore fiber is connected.

### Object of Invention

An object of the present invention is to provide a technique relating to a multicore transmission apparatus, a joint box, and a multicore fiber accommodation method that are capable of accommodating a single-core device at high density.

### Solution to Problem

A multicore transmission apparatus according to the present invention includes: a first to a fourth multicore fibers each having a plurality of cores: a first multicore processing means for outputting a plurality of light beams to mutually different cores of the second multicore fiber, the plurality of light beams being input from the cores of the first multicore fiber and individually processed: a second multicore processing means for outputting a plurality of light beams to mutually different cores of the fourth multicore fiber, the plurality of light beams being input from the cores of the third multicore fiber and being individually processed: a first joint box that accommodates the first multicore fiber, the first multicore processing means, the second multicore fiber, and the fourth multicore fiber; and a second joint box that accommodates the second multicore fiber, the third multicore fiber, the second multicore processing means, and the fourth multicore fiber.

A complex joint box according to the present invention includes: a first joint box that accommodates a first multicore fiber having a plurality of cores, a first multicore processing means for outputting a plurality of light beams to mutually different cores of a second multicore fiber having a plurality of cores, the plurality of light beams being input from the cores of the first multicore fiber and being individually processed, the second multicore fiber, and a fourth multicore fiber having a plurality of cores; and a second joint box that accommodates the second multicore fiber, a third multicore fiber having a plurality of cores, a second multicore processing means for outputting a plurality of light beams to mutually different cores of the fourth multicore fiber, the plurality of light beams being input from the cores of the third multicore fiber and being individually processed, and the fourth multicore fiber.

A multicore fiber accommodation method according to the present invention includes: accommodating, in a first joint box, a first multicore fiber having a plurality of cores, a first multicore processing means for outputting a plurality of light beams to mutually different cores of a second multicore fiber having a plurality of cores, the plurality of light beams being input from the cores of the first multicore fiber and being individually processed, the second multicore fiber, and a third multicore fiber having a plurality of cores; and accommodating, in a second joint box, the second multicore fiber, the third multicore fiber, a second multiband signal device that outputs a plurality of light beams to mutually different cores of a fourth multicore fiber having a plurality of cores, the plurality of light beams being input from the cores of the third multicore fiber and being individually processed, and the fourth multicore fiber.

### Advantageous Effects of Invention

The present invention exerts an advantageous effect that, in an optical cable system using a multicore fiber, an optical device for a single-core fiber is able to be accommodated in a multicore transmission apparatus at high density.

### BRIEF DESCRIPTION OF DRAWINGS

FIG. 1 is a diagram illustrating a configuration example of a multicore transmission apparatus 1 according to a first example embodiment.

FIG. 2 is a diagram illustrating a configuration example of a multicore transmission apparatus 2 according to a second example embodiment.

FIG. 3 is a diagram for explaining an EQL system 7.

FIG. 4 is a diagram illustrating a configuration example of a multicore transmission apparatus 2A according to a modified example of the second example embodiment.

FIG. 5 is a diagram illustrating a configuration example of a multicore transmission apparatus 3 according to a third example embodiment.

FIG. 6 is a diagram for explaining a function of the multicore device 102 according to the third example embodiment.

FIG. 7 is a diagram illustrating a configuration example of a multicore transmission apparatus 4 according to a fourth example embodiment.

FIG. 8 is a diagram illustrating a configuration example of a multicore transmission apparatus 5 according to a fifth example embodiment.

FIG. 9 is a diagram illustrating a configuration of a general multiband signal processing system 900.

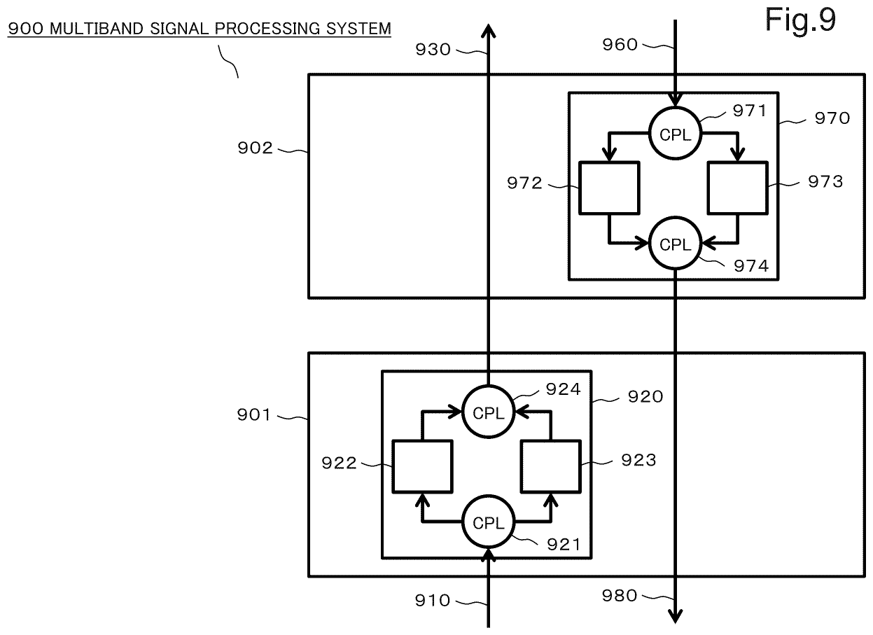

### EXAMPLE EMBODIMENT

Example embodiments of the present invention will be explained with reference to the drawings. In the following drawings, the same components are denoted by the same reference numerals, and explanation thereof will be omitted as appropriate. Also, arrows in the figures are illustrative and are not intended to limit a direction of light.

### First Example Embodiment

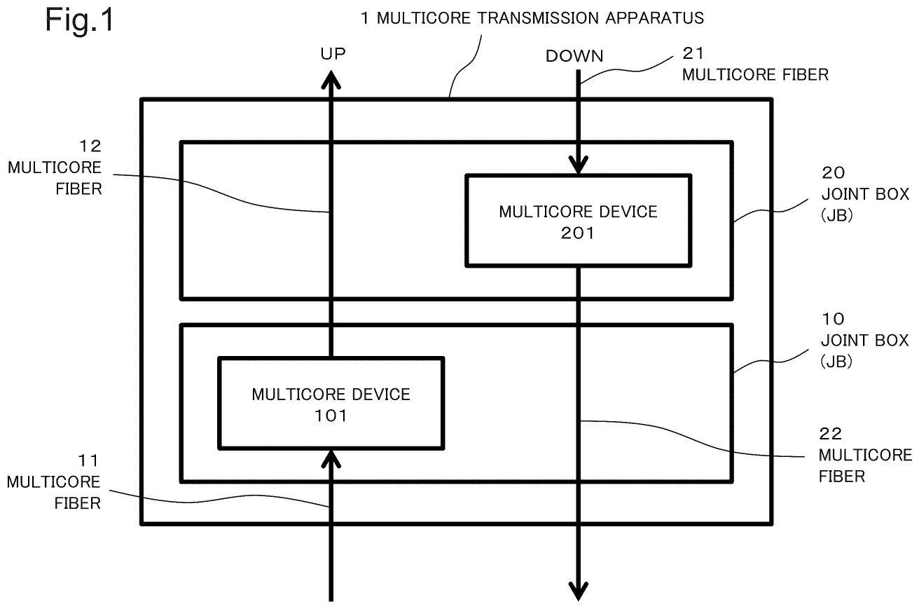

FIG. 1 is a diagram illustrating a configuration example of a multicore transmission apparatus 1 according to a first example embodiment of the present invention. The multicore transmission apparatus 1 is a transmission apparatus to be used in a multicore transmission system. The multicore transmission apparatus 1 includes multicore fibers 11 to 14, multicore devices 101 and 201, and joint boxes (JBs) 10 and 20. Each of the multicore fibers 11 to 14 is a multicore fiber having a plurality of cores. For example, the multicore fibers 11 and 12 may each include L cores and the multicore fibers 21 and 22 may each include M cores. Herein, L and M are integers of 2 or more, and L and M may be the same as or different from each other.

The multicore device 101 processes the light being input from the multicore fiber 11 and outputs the processed light to the multicore fiber 12. An orientation of the light processed by the multicore device 101 is indicated as an “UP” direction in FIG. 1. The multicore device 201 processes light being input from the multicore fiber 21, and outputs the processed light to the multicore fiber 22. An orientation of the light processed by the multicore device 201 is indicated as a “DOWN” direction in FIG. 1.

The processing in the multicore devices 101 and 201 includes, for example, at least one of equalizing, amplifying, and attenuating the input light. However, the processing is not limited thereto.

A JB 10 accommodates the multicore fiber 11, the multicore device 101, and the multicore fiber 12. A JB 20 accommodates the multicore fiber 21, the multicore device 201, and the multicore fiber 22.

In the present example embodiment, the light being input from the multicore fiber 11 and the light being input from the multicore fiber 21 are both single single-band WDM light (wavelength-multiplexed light). For example, the light being input from the multicore fiber 11 and the light being input from the multicore fiber 21 are both C-band WDM light (C-band WDM light). In addition, cross-sectional shapes of the JBs 10 and 20 in a direction perpendicular to directions of the multicore fibers 11, 12, 21, and 22 may be the same or substantially the same. Furthermore, the JB 10 and the JB 20 may each have a fitting means capable of being stack-connected to each other. The stack-connected JBs 10 and 20 can be treated as a complex joint box that is physically integrated.

In the present example embodiment, the JB 10 accommodates the multicore device 101, the multicore fibers 11 and 12 connected to the multicore device 101, and the multicore fiber 22. The multicore fiber 22 is accommodated as a pass-through multicore fiber in the JB 10. Namely, in the JB 10, the multicore fiber 22 is not connected to the multicore device 101. Therefore, an influence of accommodating the multicore fiber 22 on the cross-sectional area of the JB 10 is small.

The JB 20 accommodates the multicore device 201, the multicore fibers 21 and 22 connected to the multicore device 201, and the multicore fiber 12. The multicore fiber 12 is accommodated as a pass-through multicore fiber in the JB 20. Namely, in the JB 20, the multicore fiber 12 is not connected to other devices. Namely, in the JB 20, the multicore fiber 12 is not connected to the multicore device 201. Therefore, an influence of accommodating the multicore fiber 12 on the cross-sectional area of the JB 20 is small.

In FIG. 1, the JBs 10 and 20 are installed in series in the same direction as the multicore fibers 11, 12, 21, and 22. The JB 10 and the JB 20 accommodate the multicore device 101 or 201 and a multicore fiber connected thereto. Further, the JB 10 accommodates the pass-through multicore fiber 22, and the JB 20 accommodates the pass-through multicore fiber 12.

As illustrated in FIG. 1, the JB 10 and the JB 20 having such a configuration can be connected in series because the JBs each accommodate a pass-through multicore fiber. Then, the JB 10 processes only light propagating through the multicore fibers 11 and 12, and the JB 20 processes only light propagating through the multicore fibers 21 and 22. Thus, the JBs 10 and 20 can accommodate twice as many multicore devices as the number of multicore devices 101 or 201 that can be accommodated by one JB in these cross-sections. Herein, the cross-sections of the JBs 10 and 20 refer to a cross-section of one of the JBs 10 and 20 in a direction perpendicular to the multicore fibers 11, 12, 21, and 22 (i.e., a lateral direction of the paper surface in FIG. 1). With such a configuration, the multicore transmission apparatus 1 according to the present example embodiment exerts an advantageous effect that the multicore device can be accommodated at high density.

Note that the multicore transmission apparatus 1 according to the present example embodiment that exerts the above-described advantageous effects can also be described as follows. The associated reference signs of the elements in FIG. 1 are indicated in parentheses.

The multicore transmission apparatus (1) includes first to fourth multicore fibers (11, 12, 21, 22) each having a plurality of cores, first and second multicore processing means (101, 201), and first and second joint boxes (10, 20).

The first multicore processing means (101) outputs a plurality of lights, in which light being input from the cores of the first multicore fiber (11) is individually processed, to mutually different cores of the second multicore fiber (12).

The second multicore processing means (201) outputs a plurality of lights, in which light being input from the cores of the third multicore fiber (21) is individually processed, to mutually different cores of the fourth multicore fiber (22).

The multicore transmission apparatus described above also exerts the advantageous effect that the multicore device can be accommodated at high density.

### Second Example Embodiment

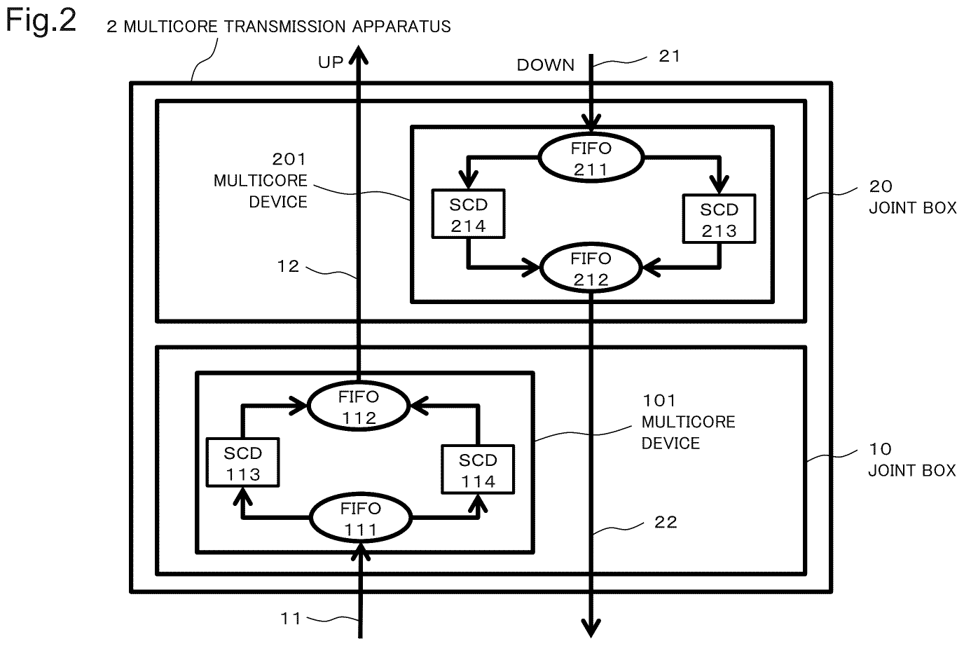

FIG. 2 is a diagram illustrating a configuration example of a multicore transmission apparatus 2 according to a second example embodiment of the present invention. In the multicore transmission apparatus 2, examples of the multicore devices 101 and 201 included in the multicore transmission apparatus 1 illustrated in FIG. 1 will be explained in more detail.

The multicore device 101 includes FIFOs 111 and 112 and single-core devices 113 and 114. In FIG. 2, the single-core device is described as a single core device (SCD). Each of the FIFOs 111 and 112 is an interface that connects a multicore fiber and a single-core fiber. The FIFO is an abbreviation for a fan-in/fan-out (Fan-In/Fan-Out).

The FIFO 111 is a fan-out, and outputs light being input from a multicore fiber 11 to a plurality of single-core fibers. The FIFO 112 is a fan-in and couples lights being output from the single-core devices 113 and 114 with different cores of a multicore fiber 12.

The FIFO 111 separates the light propagating through the plurality of cores of the multicore fiber 11 for each core, and outputs the separated lights to different single-core fibers. The single-core fibers are each connected to the single-core devices 113 and 114. In FIG. 2, one of the plurality of cores (a first core) of the multicore fiber 11 is connected to the single-core device 113, and another one of the plurality of cores (a second core) of the multicore fiber 11 is connected to the single-core device 114. Namely, the FIFO 111 outputs the light being input from the multicore fiber 11 to a plurality of single-core fibers.

The single-core devices 113 and 114 are optical devices each having a single-core fiber input and output. The single-core device 113 outputs first light having been subjected to predetermined processing on light propagated through the first core. The single-core device 114 outputs second light having been subjected to predetermined processing on light propagated through the second core. Namely, the single-core devices 113 and 114 each process the light being input from the FIFO 111 and output the processed light.

The FIFO 112 couples each of the first light and the second light with different cores of the multicore fiber 12. Namely, the FIFO 112 couples the light being output from the single-core devices 113 and 114 with the multicore fiber 12. The multicore fiber 12 transmits the first light and the second light by using different cores.

The multicore device 201 includes FIFOs 211 and 212 and single-core devices 213 and 214. Each of the FIFOs 211 and 212 is a FIFO that connects a multicore fiber and a single-core fiber. The FIFO 211 is a fan-out and the FIFO 212 is a fan-in. A configuration of the multicore device 201 with respect to WDM light in a DOWN direction is similar to the configuration of the multicore device 101 with respect to WDM light in an UP direction.

The FIFO 211 outputs the WDM light being input from the multicore fiber 21 to a plurality of single-core fibers. The single-core devices 213 and 214 each process the WDM light being input from the FIFO 211 and output the processed WDM light. The FIFO 212 couples the WDM light being output from the single-core devices 213 and 214 with the multicore fiber 22. The multicore fiber 22 transmits a plurality of WDM lights being input from the FIFO 212 by using different cores. Note that the FIFOs 111 and 211 may be referred to as a first FIFO. The first FIFO outputs the light being input from the multicore fiber to a plurality of single-core devices. Also, the FIFOs 112 and 212 may be referred to as a second FIFO. The second FIFO couples the light being output from the plurality of single-core devices with another multicore fiber.

As explained above, the multicore transmission apparatus 2 according to the present example embodiment includes JBs 10 and 20. The JB 10 includes the FIFOs 111 and 112 and the single-core devices 113 and 114. The JB 10 accommodates a multicore device 110, multicore fibers 11 and 12 connected thereto, and one pass-through multicore fiber 22.

The JB 20 includes the FIFOs 211 and 212 and the single-core devices 213 and 214. The JB 20 accommodates a multicore device 210 and multicore fibers 21 and 22 connected thereto, and one pass-through multicore fiber 12. The multicore transmission apparatus 2 having such a configuration can accommodate two optical path multicore fibers, which are one optical path (UP) composed of the multicore fibers 11 and 12 and one optical path (DOWN) composed of the multicore fibers 21 and 22.

As illustrated in FIG. 2, the multicore transmission apparatus 2 having such a configuration accommodates a multicore fiber having a pass-through in the JBs 10 and 20, and therefore, the JBs 10 and 20 can be connected in series. Then, the JB 10 processes only the light propagating through the multicore fibers 11 and 12, and the JB 20 processes only the light propagating through the multicore fibers 21 and 22.

Therefore, the multicore transmission apparatus 2 can accommodate optical fibers with two optical paths (UP and DOWN) and two multicore devices 101 and 201 in a cross section of one of the JBs 10 and 20. The two multicore devices 101 and 201 each include two single-core devices and two FIFOs. Namely, similarly to the multicore transmission apparatus 1, the multicore transmission apparatus 2 has an advantageous effect that it is possible to accommodate an optical device for a single core at high density.

### Modified Example of Second Example Embodiment

Hereinafter, an example in which the multicore transmission apparatus 2 has a function of equalizing a spectrum of WDM light will be explained.

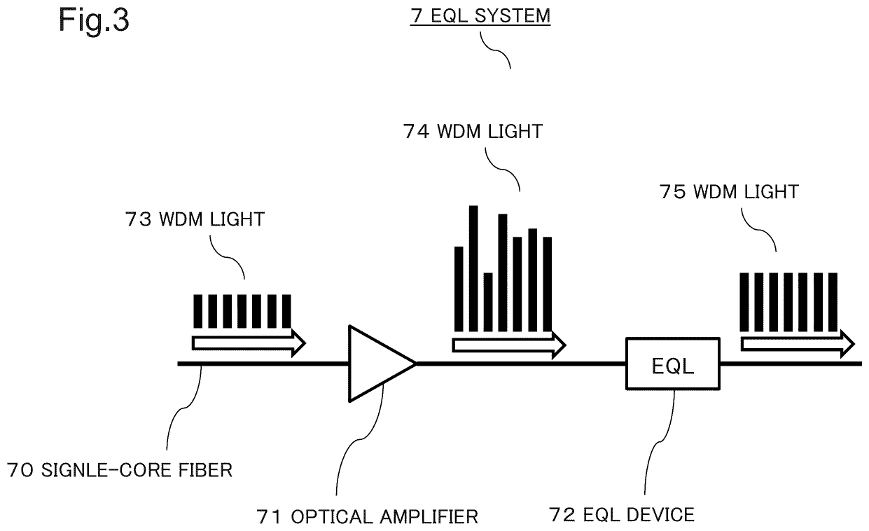

FIG. 3 is a diagram illustrating an EQL system 7. The EQL system 7 includes a single-core fiber 70, an optical amplifier 71, and an EQL device 72. In the EQL system 7, WDM light 73 propagating through the single-core fiber 70 is amplified by the optical amplifier 71 and subjected to spectral equalization (equalizing) processing in the EQL device 72. In FIG. 3, a spectrum of a plurality of optical carriers included in the WDM light propagating through the EQL system 7 at each position on the single-core fiber 70 is schematically illustrated in a bar shape with a wavelength in the lateral direction and an intensity in the longitudinal direction.

The single-core fiber 70 processes the WDM light 73 being input to the EQL system 7 by the optical amplifier 71 and the EQL device 72, and outputs the processed light as WDM light 75 to the outside of the EQL system 7.

The WDM light 73 is a single-band (e.g., C-band) WDM light. The optical amplifier 71 outputs the WDM light 74 acquired by amplifying the WDM light 73. As the optical amplifier 71, an erbium doped fiber amplifier (EDFA) is widely used. In EDFA, generally, an amplification factor of an optical signal is different for each wavelength. Therefore, even when a spectrum of the input WDM light 73 is flat, signal intensity of the output WDM light 74 differs for each wavelength. The optical amplifier 71 may be mounted in another apparatus different from the EQL device 72. The optical amplifier 71 may be connected in series in multiple stages.

The WDM light 75 amplified by the optical amplifier 71 is input to the EQL device 72. The EQL device 72 equalizes a spectrum of the WDM light 75 and outputs an equalized optical signal. By equalization, the spectrum of the WDM signal being input from the optical amplifier 71 is made flat.

In order to apply the EQL system 7 to the multicore transmission system and equalize the spectrum of the WDM light propagating through the multicore fiber, it is necessary to connect the EQL device 72 to each of the plurality of cores. In order to achieve such a configuration, the multicore transmission apparatus 2 may mount the EQL device 72 as the single-core devices 113, 114, 213, and 214.

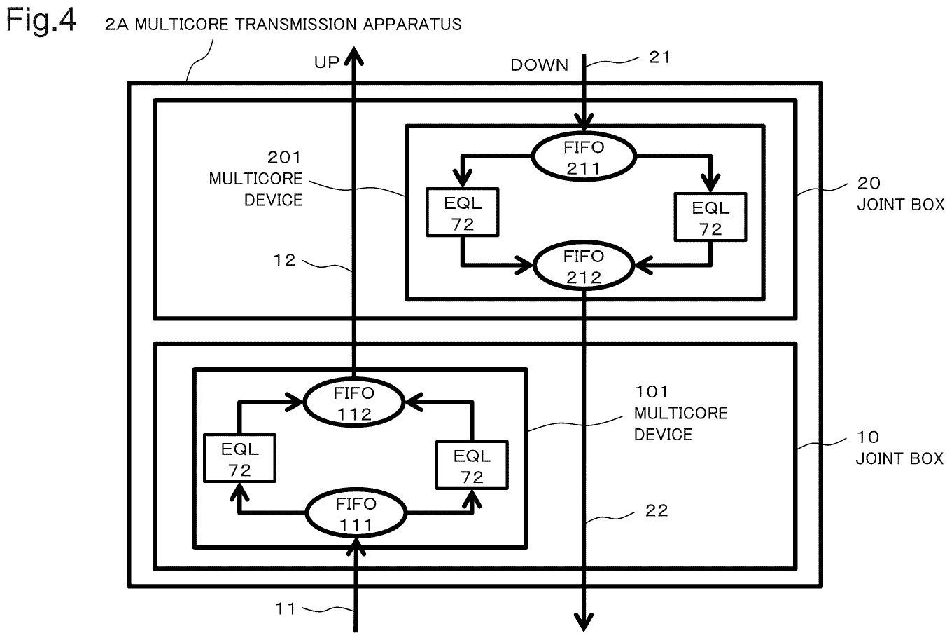

FIG. 4 is a diagram illustrating a configuration example of a multicore transmission apparatus 2A according to a modified example of the second example embodiment. The multicore transmission apparatus 2A illustrates a configuration in which the single-core devices 113, 114, 213, and 214 in the multi-core transmission apparatus 2 in FIG. 2 are replaced with EQL devices 72. The characteristics of each of these four EQL devices 72 may be set according to the characteristics of the WDM light being input from the multicore fibers 11 and 21.

The multicore transmission apparatuses 2 and 2A having such a configuration can accommodate a plurality of single-core devices (e.g., EQL devices) to be used in a multicore transmission system at high density.

A wavelength band of the WDM light propagating through the multicore fibers 11 and 21 may be the same single band (e.g., C-band). In this case, for the single-core devices 113 and 114 included in the multicore device 101, devices with the same wavelength band can be used. Similarly, the devices with the same wavelength band may be also used for the single-core devices 213 and 214 included in the multicore device 201. Single-core devices with the same wavelength band can be constituted by optical components of the same kind, and thus it is easy to make dimensions thereof common. Therefore, when the WDM light is a single band, it is easy to integrate a plurality of single-core devices into one of the multicore devices 101 and 201 at high density. Therefore, since the multicore transmission apparatuses 2 and 2A can mount a plurality of single-core devices at high density, there is an advantageous effect that miniaturization is easy.

The number of cores of the multicore fibers 11, 12, 21, and 22 connected to the multicore transmission apparatuses 2 and 2A is not limited to two. When the number of cores of the multicore fibers 11, 12, 21, and 22 becomes N (N is a natural number of 3 or more), the FIFO associated to the N cores can be used in each of the multicore devices 101 and 201. In this case, in each of the multicore devices 101 and 201, N single-core devices are required, while the number of FIFOs only needs to be two of fan-in and fan-out. Also, when the number of cores of the multicore fiber increases, as described above, when the WDM light is a single band, a plurality of single-core devices can be integrated in each of the multicore devices 101 and 201 at high density.

### Third Example Embodiment

A third example embodiment of a multicore transmission apparatus, which is based on the configurations of the multicore transmission apparatuses 1 and 2 according to the first and second example embodiments will be explained. The multicore transmission apparatus explained in the present example embodiment is a transmission apparatus to be used in a multicore transmission system. The multicore transmission apparatus according to the present example embodiment has a function of equalizing C-band WDM light.

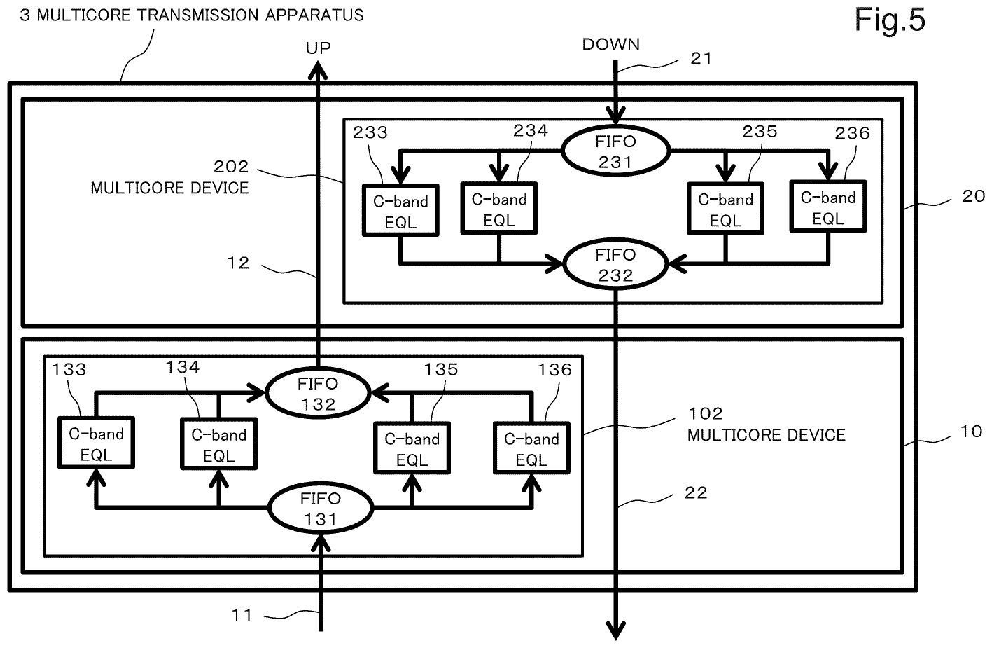

FIG. 5 is a diagram illustrating a configuration example of a multicore transmission apparatus 3 according to the third example embodiment of the present invention. The multicore transmission apparatus 3 includes a JB 10 and a JB 20. The JB 10 accommodates a multicore device 102 and multicore fibers 11, 12, and 22. The JB 20 accommodates a multicore device 202 and multicore fibers 21, 22, and 12. Each of the multicore devices 102 and 202 is one form of the multicore device 101 explained in the first example embodiment.

The multicore device 102 includes FIFOs 131 and 132, C-band EQL devices 133 to 136. The multicore device 202 includes FIFOs 231 and 232, C-band EQL devices 233 to 236. Each of the C-band EQL devices 133 to 136 and 233 to 236 is associated to the EQL device 72 in FIGS. 3 and 4.

In the present example embodiment, the multicore fiber 11 transmits four C-band WDM lights in parallel by using four cores. WDM light in an UP direction, which is input from the multicore fiber 11 to the multicore transmission apparatus 3, is separated from the multicore fiber 11 into four single-core fibers in the FIFO 131. The four single-core fibers are each connected to the C-band EQL devices 133 to 136. Each of the C-band EQL devices 133 to 136 is an equalizer for C-band WDM light having a single-core fiber as input and output, and equalizes the input WDM light. Processing of the C-band EQL devices 133 to 136 is independent, and specifications of the processing of the C-band EQL devices 133 to 136 may be the same or different. The FIFO 132 connects the single-core fiber on the output side of the C-band EQL devices 133 to 136 with the multicore fiber 12. By the FIFO 132, the four WDM lights being output from the C-band EQL devices 133 to 136 are coupled to four mutually different cores of the multicore fiber 12.

WDM light in a DOWN direction, which is input into the multicore transmission apparatus 3, is also subjected to the similar processing. Namely, the multicore fiber 21 transmits the C-band WDM light by using four cores. The WDM light in the DOWN direction, which is input from the multicore fiber 21, is separated from the multicore fiber 21 into four single-core fibers in the FIFO 231. The four single-core fibers are connected to the C-band EQL devices 233 to 236. Each of the C-band EQL devices 233 to 236 is an equalizer for C-band WDM light having a single-core fiber as input and output, and equalizes the input WDM light. The processing of the C-band EQL devices 233 to 236 is independent, and specifications of the processing of the C-band EQL devices 233 to 236 may be the same or different. The FIFO 232 connects the single-core fibers on an output side of the C-band EQL device 233 to 236 with the multicore fiber 22. By the FIFO 232, the four WDM lights, which are output from the C-band EQL devices 233 to 236, are coupled to four mutually different cores of the multicore fiber 22.

In the multicore transmission apparatus 3, the JB 10 and the JB 20 are connected in series, the JB 10 processes the light in the UP direction, and the JB 20 processes a signal in the DOWN direction. In the cross section of the JB 10 and JB 20, the multicore transmission apparatus 3 can accommodate the multicore fibers 11 to 12 and 21 to 22, the C-band EQL devices 133 to 136 and 233 to 236, and the four FIFO 131 to 132 and 231 to 232.

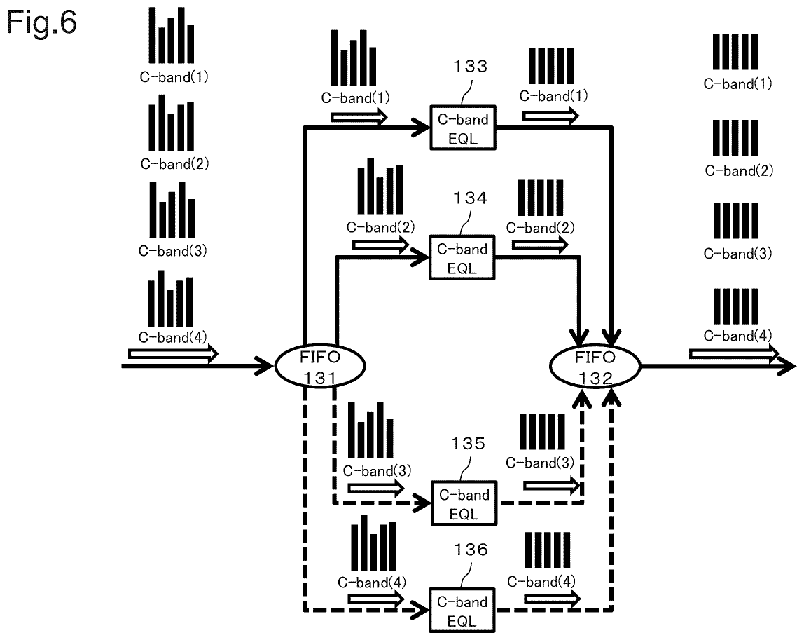

FIG. 6 is a diagram for explaining a function of the multicore device 102 according to the third example embodiment. The multicore device 102 is included in the JB 10 in FIG. 5. Four C-band WDM lights (C-bands (1) to (4)) are input to the FIFO 131. The C-bands (1) to (4) are each transmitted by different cores of the multicore fiber 12. In FIG. 6, spectra of a plurality of optical carriers included in the four C-band WDM lights at positions inside the multicore device 102 are schematically illustrated in a bar shape with a wavelength in the lateral direction and an intensity in the longitudinal direction.

The FIFO 131 distributes cores of four multicore fibers that transmit the WDM light to the single-core fibers. The four WDM lights distributed to the single-core fiber are equalized by the C-band EQL devices 133 to 136. The equalized WDM light is input to the multicore fiber 12 via the FIFO 132. In this way, the multicore device 102 can equalize the four WDM lights transmitted through the multicore fiber 11 for each core, and transmit the equalized WDM lights through the multicore fiber 12. Namely, the multicore device 102 can equalize the WDM light transmitted through the multicore fiber for each core by using the single-core device.

As described above, the multicore transmission apparatus 3 also has an advantageous effect of being able to accommodate optical devices to be used in the multicore transmission system at high density. Further, as described in the second example embodiment, the multicore transmission apparatus 3 can also integrate a plurality of single-core devices at high density in each of the multicore devices 102 and 202 even when the number of cores of the multicore fiber increases.

### Fourth Example Embodiment

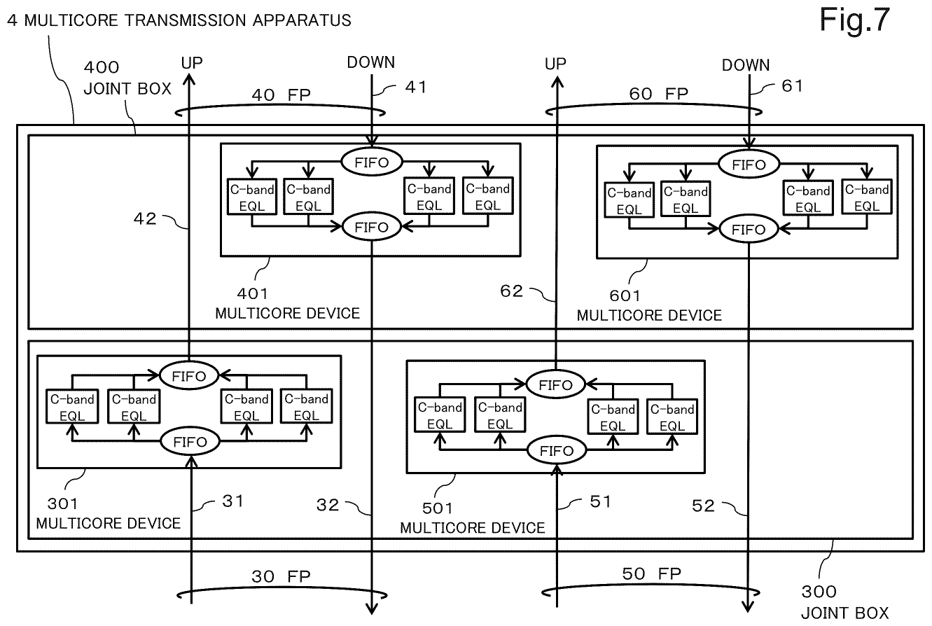

FIG. 7 is a diagram illustrating a configuration example of a multicore transmission apparatus 4 according to a fourth example embodiment. Four sets of fiber pairs (FPs) 30, 40, 50, and 60 are connected to the multicore transmission apparatus 4. The fiber pair 30 includes multicore fibers 31 and 32, and the fiber pair 40 includes multicore fibers 41 and 42. The fiber pair 50 includes multicore fibers 51 and 52, and the fiber pair 60 includes multicore fibers 61 and 62.

As for the fiber pairs 30 and 40, a JB 300 accommodates a multicore device 301, multicore fibers 31 and 42 in an UP direction, and a multicore fiber 32 in a DOWN direction. In addition, a JB 400 accommodates a multicore device 401, a multicore fiber 41 and the multicore fiber 32 in the DOWN direction, and the multicore fiber 42 in the UP direction.

As for the fiber pairs 50 and 60, the JB 300 accommodates a multi-core device 501, multi-core fibers 51 and 62 in the UP direction, and a multicore fiber 52 in the DOWN direction. In addition, the JB 400 accommodates a multicore device 601, a multicore fiber 61 and the multicore fiber 52 in the DOWN direction, and the multicore fiber 62 in the UP direction.

Each of the multicore devices 301 and 501 has similar configuration and function to the multicore device 102 in the third example embodiment. Each of the multicore devices 401 and 601 has similar configuration and function to the multicore device 202 in the third example embodiment. Namely, the multicore transmission apparatus 4 is formed by arranging two sets of the multicore transmission apparatuses 3 illustrated in FIG. 5 in parallel. The multicore devices 301 and 501 are accommodated in the JB 300, and the multicore devices 401 and 601 are accommodated in the JB 400.

In the multicore transmission apparatus 4, the JB 300 accommodates multicore devices 301 and 501 that process WDM light in the UP direction, the multicore fibers 31, 42, 51, and 62 in the UP direction, and the multicore fibers 32 and 52 in the DOWN direction. In the JB 300, the multicore fibers 32 and 52 are passed through. Therefore, the JB 300 does not include a multicore device that processes WDM light in the DOWN direction.

In addition, the JB 400 accommodates multicore devices 401 and 601 that process WDM light in the DOWN direction, the multicore fibers 41, 32, 61, and 52 in the DOWN direction, and the multicore fibers 42 and 62 in the UP direction. In the JB 400, the multicore fibers 32 and 52 are passed through. Therefore, the JB 400 does not include a multicore device that processes WDM light in the UP direction.

In the multicore transmission apparatus 4, two sets of the fiber pairs 30 and 50 and multicore devices 301, 401, 501 and 601 are accommodated in cross sections of the JB 300 and the JB 400 installed in series. The two JBs 300 and 400 each accommodate a pass-through multicore fiber, and thus can be connected in series with each other. Thus, the two joint boxes can accommodate twice the number of single-core devices that can be accommodated by one joint box in the cross section of one joint box in a direction perpendicular to the multicore fiber.

Therefore, the multicore transmission apparatus 4 according to the present example embodiment has an advantageous effect that a single-core device to be used in a multicore transmission system can be accommodated at high density. Similarly to the second and third example embodiments, the multicore transmission apparatus 4 can integrate a plurality of single-core devices at high density in each of the multicore devices 301, 401, 501, and 601 even when the number of cores of the multicore fiber increases.

FIG. 7 illustrates a configuration example of the multicore transmission apparatus 4 in which two sets of fiber pairs are accommodated in the JBs 300 and 400. However, the configuration of the multicore transmission apparatus 4 is not limited to this. The multicore transmission apparatus 4 may include three or more joint boxes connected in series. For example, third and fourth joint boxes to be added may have similar configurations to the JBs 300 and 400 in order to process WDM light transmitted in a third set and a fourth set of fiber pairs, which are to be added. In other words, in the multicore transmission apparatus 4, 2N (N is a natural number) joint boxes may be connected in series with each other. In this case, 2N joint boxes connected in series can accommodate 2N sets of fiber pairs. Then, in a cross section of one of the 2N joint boxes, compared to a case of two joint boxes, it is possible to accommodate N times the number of multicore devices.

Also, the JBs 300 and 400 may each include three or more multicore devices and accommodate more fiber pairs.

### Fifth Example Embodiment

The multicore transmission apparatus 4 explained in the fourth example embodiment, the JB 300 includes the multicore devices 301 and 501 for WDM light in the UP direction, and the JB 400 includes multicore devices 401 and 601 for WDM light in the DOWN direction. However, a multicore device for the UP direction and a multicore device for the DOWN direction may be accommodated in one joint box.

In a multicore transmission apparatus 5 according to the present example embodiment, two multicore devices that each process WDM light propagating through a set of fiber pairs in the UP direction and the DOWN direction are accommodated in the same joint box.

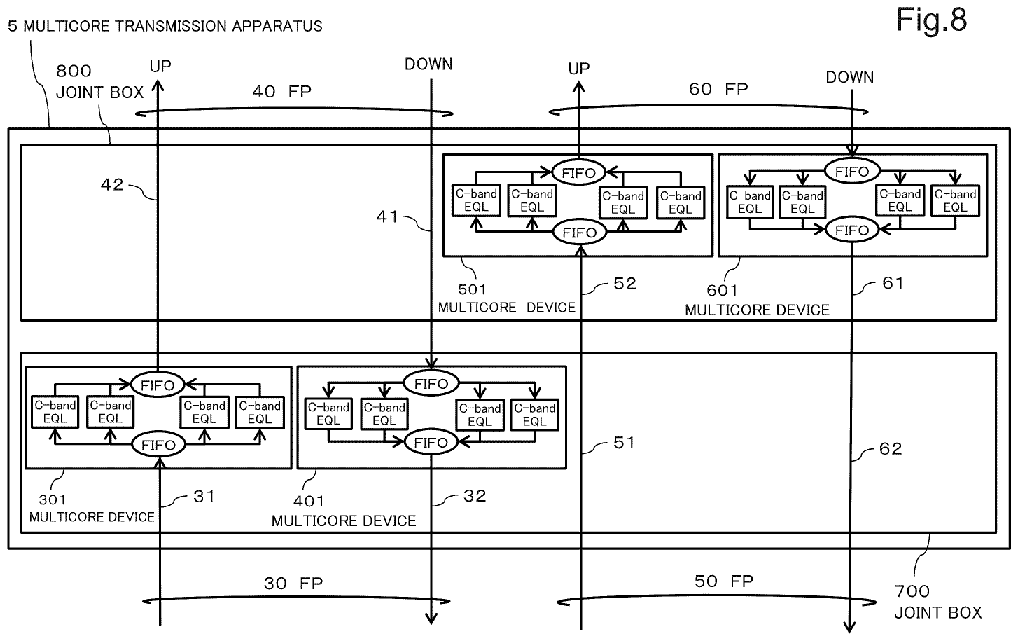

FIG. 8 is a diagram illustrating a configuration example of the multicore transmission apparatus 5 according to the fifth example embodiment. In FIG. 8, reference numerals of the fiber pair, the multicore fiber, and the multicore device in FIG. 7 are applied mutatis mutandis. The multicore transmission apparatus 5 accommodates fiber pairs 30, 40, 50, and 60.

As for the fiber pairs 30 and 40, a JB 700 accommodates multicore devices 301 and 401, multicore fibers 31 and 42 in the UP direction, and multicore fibers 41 and 32 in the DOWN direction. Also, a JB 800 accommodates the multicore fibers 41 and 42 (i.e., the fiber pair 40) in such a way as to pass through.

As for the fiber pairs 50 and 60, the JB 800 accommodates multicore devices 501 and 601, multicore fibers 51 and 62 in the UP direction, and multicore fibers 61 and 52 in the DOWN direction. Also, the JB 700 accommodates the multicore fibers 51 and 52 (i.e., the fiber pair 50) in such a way as to pass through.

The multicore transmission apparatus 5 differs from the multicore transmission apparatus 4 in that the multicore device 401 is included in the JB 700 and the multicore device 501 is included in the JB 800. The multicore device 401 included in the multicore transmission apparatus 5 has a similar function to the multicore device 401 included in the multicore transmission apparatus 4 according to the fourth example embodiment. With such a configuration, in the multicore transmission apparatus 5, the JB 700 equalizes WDM lights in the UP direction and the DOWN direction of the fiber pairs 30 and 40. The JB 800 also equalizes the WDM lights in the UP direction and DOWN direction of the fiber pairs 50 and 60. Namely, in the multicore transmission apparatus 5, one joint box equalizes WDM light of a set of fiber pairs on the same optical path.

In the multicore transmission apparatus 5, the JB 700 and the JB 800 are connected in series, the JB 700 equalizes the WDM light of the fiber pairs 30 and 40, and the JB 800 equalizes the WDM light of the fiber pair 40. In cross sections of the JB 700 and the JB 800, the multicore transmission apparatus 5 can accommodate the fiber pairs 30, 40, 50, and 60 and the multicore device 301, 401, 501, and 601. The multicore transmission apparatus 5 having such a configuration has an advantageous effect that the optical device to be used in the multicore transmission system can be accommodated at high density, similarly to the multicore transmission apparatus 4 according to the fourth example embodiment. Also, the multicore transmission apparatus 5 can integrate a plurality of single-core devices into each of the multicore devices 301, 401, 501, and 601 at high density when the number of cores of the multicore fiber increases.

In the multicore transmission apparatus 5 according to the present example embodiment, the multicore devices 301 and 401 are both accommodated in the JB 700. Therefore, when performing characteristic measurement and setting change for the multicore device accommodated in the fiber pairs 30 and 40 constituting the same optical path, a user only needs to access the JB 700. The same applies to the multicore devices 501 and 601 connected to the optical path constituted by the fiber pairs 50 and 60. Namely, the multicore transmission apparatus 5 has an advantageous effect that maintenance is easy.

Note that the number of multicore fiber pairs to be passed through in one joint box may be further increased, and the number of stages of series connection of the joint boxes may be further increased. With such a configuration, the number of fiber pairs that can be processed in the multicore transmission apparatus 5 can be increased without enlarging the cross section of each joint box.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

### REFERENCE SIGNS LIST

1, 2, 2A, 3 to 5 Multicore transmission apparatus
7 EQL system
10, 20, 300, 400, 700, 800 Joint box (JB)
11 to 14, 21 to 22, 31 to 32, 41 to 42 Multicore fiber
51 to 52, 62 to 62 Multicore fiber
30, 40, 50, 60 Fiber pairs (FP)
70 Single-core fiber
71 Optical amplifier
72 EQL device
73 to 75 WDM light
101 to 102, 110, 201 to 201, 210 Multicore device
113 to 114, 213 to 214 Single-core device
133 to 136, 233 to 236 C-band EQL device
301, 401, 501, 601 Multicore device
900 Multiband signal processing system
901, 902 Joint box
910, 930, 960, 980 Signal cable
920, 970 Multiband signal device
921, 924 Coupler
922 to 923 EQL device

What is claimed is:

1. A multicore transmission apparatus comprising:
first to fourth multicore fibers each having a plurality of cores;
a first multicore processor configured to output a plurality of light beams to mutually different cores of the second multicore fiber, the plurality of light beams being input from the cores of the first multicore fiber and being individually processed;
a second multicore processor configured to output a plurality of light beams to mutually different cores of the fourth multicore fiber, the plurality of light beams being input from the cores of the third multicore fiber and being individually processed;
a first joint box that accommodates the first multicore fiber, the first multicore processor, the second multicore fiber, and the fourth multicore fiber; and
a second joint box that accommodates the second multicore fiber, the third multicore fiber, the second multicore processor, and the fourth multicore fiber.

2. The multicore transmission apparatus according to claim 1, wherein each of the first joint box and the second joint box includes a connector that is capable of being stack-connected to each other.

3. The multicore transmission apparatus according to claim 1, wherein a wavelength band of light propagating in each of the cores of the first and third multicore fibers is single single-band wavelength division multiplexing (WDM) light.

4. The multicore transmission apparatus according to claim 3, wherein each wavelength band is same.

5. The multicore transmission apparatus according to claim 4, wherein the wavelength band is a C-band.

6. The multicore transmission apparatus according to claim 1, wherein
each of the first multicore processor and the second multicore processor includes:
a first FIFO that outputs light being input from a multicore fiber to a plurality of single-core devices;
a plurality of single-core devices that process light being input from the first FIFO and outputs the processed light; and
a second FIFO that couples light being output from the plurality of single-core devices with another multicore fiber.

7. The multicore transmission apparatus according to claim 1, wherein processing in the plurality of single-core devices includes at least one of equalizing, amplifying, and attenuating the input light.

8. A complex joint box comprising:
a first joint box accommodating
a first multicore fiber having a plurality of cores,
a first multicore processor configured to output a plurality of light beams to mutually different cores of a second multicore fiber having a plurality of cores, the plurality of light beams being input from the cores of the first multicore fiber and being individually processed,
the second multicore fiber, and
a fourth multicore fiber having a plurality of cores; and
a second joint box accommodating
the second multicore fiber,
a third multicore fiber having a plurality of cores,
a second multicore processor configured to output a plurality of light beams to mutually different cores of the fourth multicore fiber, the plurality of light beams being input from the cores of the third multicore fiber and being individually processed, and
the fourth multicore fiber.

9. The complex joint box according to claim 8, wherein the first joint box and the second joint box are connected by a connector that is capable of being stack-connected.

10. A multicore fiber accommodation method comprising:
accommodating, in a first joint box, a first multicore fiber having a plurality of cores, a first multicore processor configured to output a plurality of light beams to mutually different cores of a second multicore fiber having a plurality of cores, the plurality of light beams being input from the cores of the first multicore fiber and being individually processed, the second multicore fiber, and a third multicore fiber having a plurality of cores; and
accommodating, in a second joint box, the second multicore fiber, the third multicore fiber, second multicore processor configured to output a plurality of light beams to mutually different cores of a fourth multicore fiber having a plurality of cores, the plurality of light beams being input from the cores of the third multicore fiber and being individually processed, and the fourth multicore fiber.
